(19) United States
(12) Patent Application Publication
(10) Pub. No.: US 2007/0101548 A1
(43) Pub. Date: May 10, 2007

(54) Potholder table runner

(75) Inventor: Wendy Alexandria Whitson, Leaburg, OR (US)

Correspondence Address: Wendy Whitson, P.O. Box 112, Vida, OR, 97488, US

(73) Assignee: Wendy Whitson, Vida, OR (US)

(21) Appl. No.: 11/267,679

(22) Filed: Nov. 7, 2005

(51) Int. Cl. A47J 45/10

(52) U.S. Cl. 16/435

(57) ABSTRACT

The present invention pertains generally to the use of potholders used for cooking. Potholders are typically an individual potholder for each hand and a potholder on the counter to set the hot dish on, a total of three potholders. The present invention pertains to only using one potholder serving the purpose of three potholders.

### BACKGROUND OF THE INVENTION

The present invention pertains generally to the use of potholders used for cooking. Potholders are typically an individual potholder for each hand and a potholder on the counter to set the hot dish on, a total of three potholders. The present invention pertains to only using one potholder serving the purpose of three potholders.

### BRIEF SUMMARY

This invention has exterior fabric shell. There are two pockets to which each hand will be put in order to pick up a hot dish. The pockets are located (sewn) at each end of the Potholder Table Runner. There is a liner between the fabrics to protect from hot items. As the hand is placed in each pocket, it is then safe to pick up the hot dish.

The center of the Potholder Table Runner is where the hot dish will be set down on. Remove hands from pockets lay Potholder Table Runner flat and there is room for other hot dishes to set. Important objective of the present invention conclude the use of one potholder compared to past inventions of using 3 potholders to serve the same purpose.

### BRIEF DESCRIPTION OF DRAWINGS

In the accompanying drawings:

FIG. 1 is the front view of the Potholder Table Runner showing where the 2 pockets are located.

FIG. 2 is the back view of the Potholder Table Runner.

FIG. 3 is the side view of Potholder Table Runner with a hot dish.

FIG. 4 is the flat side view of the Potholder Table Runner.

### DETAILED DESCRIPTION OF THE INVENTION

The Potholder Table Runner consists of a fabric shell. There are 2 pieces of fabric sewn together with a liner inside the garment to protect the hands and counter from burning.

In place at each end of Potholder Table Runner is fabric sewn to make a pocket to serve as potholders. The pockets can a square as shown in the drawings or can be any shape as long as it is serves as a pocket. This is used as a table runner to set a hot dish and the potholder to protect the counter.

A Potholder Table Runner having it long enough for the purpose of eliminating using more than one potholder.

Adding or taking away from the Potholder Table Runner such as pockets on both sides of the Potholder Table Runner or eliminating the pockets and replacing with a strap can be changed without losing the integrity of the patent.

While I have shown but one embodiment of the invention, it may be apparent to those skilled in the art that the invention may be embodied still otherwise without departing from the spirit and scope of the invention.

Having thus described the invention, what is desired to be secured by a patent is:

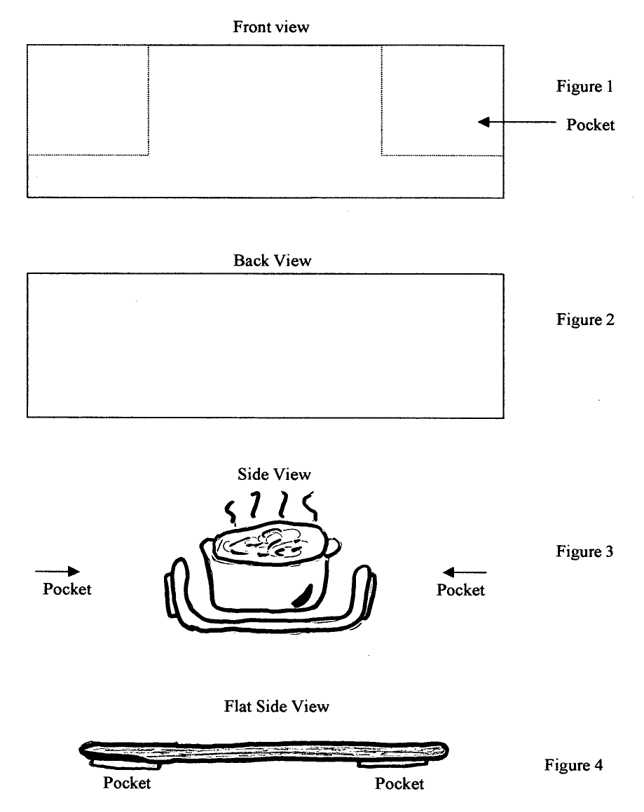

1. A Potholder Table Runner having a fabric shell and a liner between the shell to protect the hands and counter from hot dishes. This item has a pocket sewn on each end to put the hand in order to pick up a hot dish. The pocket can be a square like the drawing (FIG. 1) or any shape as long as it serves the purpose of a pocket.
This Potholder Table Runner is long enough to pick up a hot dish using the side pockets and able to set a dish on the Potholder Table Runner. Thus eliminating the use of three pot holders.
The present invention comprised of:
Fabric shell
Liner inside to protect hands from hot items
Pockets in order to pick up a hot item
Long enough to pick up a hot items using the side pockets
